(19) United States
(12) Patent Application Publication
(10) Pub. No.: US 2008/0070627 A1
(43) Pub. Date: Mar. 20, 2008

(54) Integrated SIM system

(75) Inventor: Khein-Seng Pua, Hsinchu (TW)

Correspondence Address: BACON & THOMAS, PLLC, 625 SLATERS LANE, FOURTH FLOOR, ALEXANDRIA, VA, 22314, US

(73) Assignee: Phison Electronics Corp., Hsinchu (TW)

(21) Appl. No.: 11/522,488

(22) Filed: Sep. 18, 2006

(51) Int. Cl. H04B 1/38; H04M 1/00

(52) U.S. Cl. 455/558

(57) ABSTRACT

An integrated SIM system for use with a communication terminal is disclosed. Meanwhile, the integrated subscriber identity module (SIM) system for use with a communication terminal includes a SIM unit for allowing communication between the communication terminal and an external base station; a memory module stored with a virtual machine (VM) for providing the communication terminal with a platform for various applications; and a controlling module for acting as an interface between the communication terminal and the SIM unit/memory module to access one of the SIM unit and the memory module.

### FIELD OF THE INVENTION

The present invention relates to an integrated SIM system, and more particularly, to an integrated SIM system for use with a communication terminal, i.e., a mobile phone.

### BACKGROUND OF THE INVENTION

In a known conventional GSM system, each mobile station, such as a mobile telephone handset, is provided with a SIM, herein also referred to as a smart card, which is inserted into the mobile station in order to allow the mobile station to receive service in a GSM network.

A typical SIM includes a microprocessor, memory elements including a permanent memory (e.g. ROM), a non-volatile rewritable memory (e.g. EEPROM) and a volatile rewritable memory (e.g. RAM), and contacts for forming the data transfer interface between the SIM and the mobile station.

The GSM standard also specifies a command set for use by a mobile station to access data records in the SIM and retrieve and write data from and to the SIM. Such data records may be permanent data records, such as a record of the international mobile subscriber identity (IMSI) whereby the mobile subscriber is recognized by a mobile communications network.

Other data records are modifiable, either at the initiative of the mobile station (such as the data record holding the current location area information (LAI) for the mobile station) or at the initiative of the mobile subscriber (such as an abbreviated dialing number (ADN) record which is used to allow the subscriber to automatically initiate calling of the stored dialing number by selection of the associated dialing number identifier when displayed by the mobile station).

Other modifiable data records include a short message data record, which stores data relating to one or more short messages in alphanumeric characters received by the mobile station, for future retrieval by the subscriber.

For more details of the records which may be stored in a SIM, reference should be made to GSM Technical Specification 11.11 (ETS 300 608).

The memory capacity of the SIM is necessarily limited, primarily due to cost considerations.

Accordingly, the data records referred to above are limited in size and number in accordance with the memory capacity of the SIM, which can be a drawback. For example, in the case of ADN records, it is conventional to allocate sufficient memory capacity dedicated to an ADN list such that up to 90 ADN records can be provided. Some subscribers however require a greater ADN storage capacity. This is evidenced by the fact that ADN storage capacity is used as a positive marketing point by suppliers who are able to provide SIM's having relatively large ADN storage capacities. However, with a fixed amount of total memory capacity available, an increase in the memory capacity allocated to ADN records must be compensated for by a reduction in the memory capacity allocated to other data records.

One drawback for terminal equipment manufacturers is the significant cost caused by design, structural and size limitations of SIM card. The arrangement of standard connections for the SIM card in the terminal equipment constitutes a significant cost in production of terminal equipment. Furthermore, another drawback is the risk of destruction of data stored in SIM cards. The prior art presents a method for carrying out a smart card facility, which allows implementation of comprehensive services with the data communication device. However, this provides no solution to the drawbacks mentioned above. The prior art merely provides a SIM card with size limitations, and the SIM card could not store a Java virtual machine and other application programs for the terminal equipment. On the other hand, the use of mobile telecommunications is rapidly increasing in both the private and business sectors. In an effort to attract new customers and to keep existing customers, network operators try to offer a variety of service options. Ideally, network operators would like to introduce new services quickly and to have these services unique to their own networks. Hence, the compatibility between the developing SIM card system and the terminal system should be considered. The invention disclosed herein fulfills this need.

Therefore, it needs to provide an integrated SIM-card system for use in the communication terminal, which introduces an integrated SIM system integrating a controlling module and a NAND flash module with an ordinary SIM card for providing the application programs with more memory space and facilitating to extend the services from the SIM card. Hence, the present invention can overcome those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide an integrated SIM-card system for use in the communication terminal, which integrates a controlling module and a NAND flash module with the original SIM card for providing the application programs with more memory space and facilitating to extend the services from the original SIM card, and can rectify those drawbacks of the prior art and solve the above problems.

In accordance with an aspect of the present invention, the integrated subscriber identity module (SIM) system for use with a communication terminal includes a SIM unit for allowing communication between the communication terminal and an external base station; a memory module stored with a virtual machine (VM) for providing the communication terminal with a platform for various applications; and a controlling module for acting as an interface between the communication terminal and the SIM unit/memory module to access one of the SIM unit and the memory module.

Certainly, the communication terminal is one of a mobile phone and a personal digital assistant.

Preferably, the memory module is a NAND flash memory.

Certainly, the controlling module, the SIM unit and the memory module are incorporated into a standard SIM card.

Preferably, the virtual machine (VM) is a Java virtual machine (VM).

Preferably, the applications are executed via the virtual machine (VM).

The above objects and advantages of the present invention will become more readily apparent to those ordinarily skilled in the art after reviewing the following detailed description and accompanying drawings, in which:

### BRIEF DESCRIPTION OF THE DRAWING

FIG. 1. illustrates an integrated SIM system for use with a communication terminal according to the present invention;

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

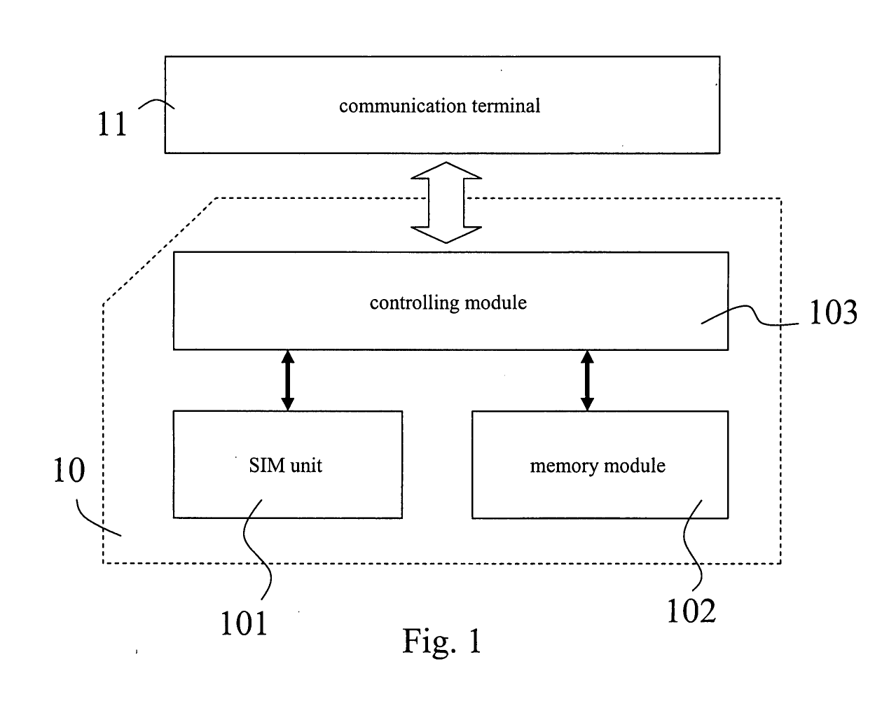

Please refer to FIG. 1. It illustrates an integrated SIM system shaped as a Standard SIM card for use with a communication terminal according to the present invention. The integrated SIM system 10 shaped as a Standard SIM card for use with a communication terminal 11, includes a SIM memory 101 for storing identification information of the communication terminal 11; an memory 102 for storing applications of the communication terminal 11; and a controlling module 103 contacted with the SIM memory 101 and the memory 102 for providing an interface to the communication terminal 11, wherein the controlling module 103 determines to access to the SIM memory 101 for the identification information, and to the memory 102 for the applications.

In practice, the communication terminal 11 can be one of a mobile phone and a personal digital assistant. In this embodiment, the communication 11 is a mobile phone. Moreover, the integrated SIM system 10 is shaped as a Standard SIM card, and could be able to insert into a standard SIM card holder (not shown) of the communication terminal 11. Being different from the original SIM card of the prior art, the integrated SIM system further introduces the memory 102 for providing an interface to the communication terminal 11, wherein the memory 102 can be a NAND flash memory. Obviously, the integrated SIM system 10 provides more memory space for user, wherein the memory 102 could store a lot of application programs. On the other hand, the present invention further introduces the controlling module 103 as the interface connected with the communication terminal, wherein a universalized mobile-platform is formed by means of combining the memory 102 and the controlling module 103. Therefore, the present invention will be able to introduce new services quickly and to have more services unique to the network. Furthermore, in the embodiment, the present invention could introduce a standard Java Virtual machine (VM) into the combo-SIM system (stored in the memory 102 and accessed via the controlling module 103) to providing a universalized mobile-platform, thereby increasing the currency of application programs used in the communication terminal and facilitating to develop application programs.

In conclusion, the present invention provides an integrated SIM-card system for use in the communication terminal, which integrates a controlling IC module and a NAND flash module with the original SIM card for providing the application programs with more memory space and facilitating to extend the services from the original SIM card. Furthermore, the present invention could introduce a standard Java Virtual machine (VM) into the combo-SIM system to providing a universalized mobile-platform, thereby increasing the currency of application programs used in the communication terminal and facilitating to develop application programs, but the prior art fail to disclose that. Accordingly, the present invention possesses many outstanding characteristics, effectively improves upon the drawbacks associated with the prior art in practice and application, bears novelty, and adds to economical utility value. Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. An integrated subscriber identity module (SIM) system for use with a communication terminal, comprising:
a SIM unit for allowing communication between said communication terminal and an external base station;
a memory module stored with a virtual machine (VM) for providing said communication terminal with a platform for various applications; and
a controlling module for acting as an interface between said communication terminal and said SIM unit/memory module to access one of said SIM unit and said memory module.

2. The integrated SIM system according claim 1, wherein said communication terminal is one of a mobile phone and a personal digital assistant.

3. The integrated SIM system according claim 1, wherein said memory module is a NAND flash memory.

4. The integrated SIM system according claim 1, wherein said controlling module, said SIM unit and said memory module are incorporated into a standard SIM card.

5. The integrated SIM system according claim 1, wherein said virtual machine (VM) is a Java virtual machine (VM).

6. The integrated SIM system according claim 1, wherein said applications are executed via said virtual machine (VM).
